(19) United States
(12) Patent Application Publication
(10) Pub. No.: US 2006/0130524 A1
(43) Pub. Date: Jun. 22, 2006

(54) Method and apparatus for making optical fibres

(75) Inventors: Anssi Hovinen, Espoo (FI); Janne Kesala, Espoo (FI); Pekka Soininen, Helsinki (FI)

Correspondence Address: SUGHRUE MION, PLLC, 2100 PENNSYLVANIA AVENUE, N.W., SUITE 800, WASHINGTON, DC, 20037, US

(73) Assignee: NEXTROM HOLDING S.A.

(21) Appl. No.: 10/537,496

(22) PCT Filed: Dec. 5, 2003
(86) PCT No.: PCT/FI03/00934

§ 371 Date: Dec. 14, 2005

(30) Foreign Application Priority Data
Dec. 5, 2002 (FI) 20022162

(51) Int. Cl. C03B 37/018

(52) U.S. Cl. 65/32.5; 65/157; 65/417

(57) ABSTRACT

Method and apparatus for producing glass products of predetermined shape. In the method, a perform is introduced into a furnace and heated to a temperature above the softening point of the glass. The heated portion is subjected to tensile forces and drawn from the furnace through an outlet opening. During processing, inert gas is fed into the furnace. According to the invention, the concentration of gaseous impurities in the furnace is maintained on the same level as in the inert gas fed into the oven. To prevent inflow of undesired gaseous components from the ambient air, a diffusion barrier is established by generating a barrier flow of inert gas in the inlet or outlet openings. This barrier flow has a direction of flow, which is opposite to the direction of the diffusion. The invention provides non-contacting sealing between the furnace and the preform while optimizing the consumption of protective gas. The invention also allows for simultaneous rotation of the preform.

### BACKGROUND OF THE INVENTION

1. Field of the Invention

The present invention relates to the manufacture of optical fibres. In particular, the invention concerns a method according to the preamble of claim 1 of subjecting a glass preform to processing by tensile forces in a heating oven for making optical fibres or for stretching of the glass perform into a form suitable for fibre manufacture.

The present invention can be used also in other preform-making processes and equipment thereof, like in MCVD lathes and sintering furnaces, as defined in the preamble of claim 28.

Generally, the present invention can be utilised in a large variety of processes for heat-treatment of glass substrates, in which the glass substrate is placed in the first gas space of a heat treatment zone, surrounded by a second, ambient gas space, said heat treatment zone being provided with gas conduits between and preferably interconnecting the first and the second gas spaces. Typically, in the heat-treatment processes the gas conduits comprise rotary joints. Treatment is carried out at moderate to high temperatures (over 300° C., in most cases over 1000° C., frequently over 1500° C.). The gas atmospheres (i.e. the composition of the gas spaces) on both sides of the gas conduits are different. Often there is a pressure difference (of up to 1000 mbar, preferably up to 100 mbar) between the atmosphere prevailing inside the equipment employed for processing of the preforms and the atmosphere prevailing outside it.

The present invention is also concerned with an apparatus according to the preamble of claim 17 for processing of glass performs.

2. Description of Related Art

In the manufacture of optical fibres, a glass preform, comprising, for example, a layered glass structure, is drawn through a furnace having a jacket defining an elongated heating chamber, with a vertically or horizontally oriented central axis, in which the preform is heated to temperatures in the range of about 1800 to 2200° C. in order to soften the glass. In practice, furnaces having either ZrO or graphite resistances (resistance heating or induction heating) are used. In both cases, at the inlet opening, through which the, for example, vertically suspended glass preform extends into the oven, a seal is provided. The seal can comprise a mechanical ring, such as a mechanical iris structure, which will reduce the clearing between the inlet orifice and the exterior walls of the preform.

With furnaces having ZrO resistances, the processing can be carried out in ambient atmosphere and the sealing efficiency of the inlet orifice is not critical. Nor is there any particular need for minimizing the clearing between the glass preform and the inner surface of the inlet opening. However, these furnaces are hampered by the considerable disadvantage that the constructions are destroyed, if they is allowed to cool down during operation. Thus, particularly difficult situations may arise during power failures and similar malfunctions.

The second heating oven, viz. the graphite furnace, is used more extensively. In order to avoid burning the graphite, the graphite parts of the furnace should be kept in a protective atmosphere at temperatures over 500° C. It can be noted that not only is it expensive to renew the graphite resistances, which have been burnt, but glowing and smoking graphite also causes formation of particles that weakens the properties of the fibre. Therefore, in case of graphite furnaces, an essential part in controlling the protective atmosphere is the provision of an efficient sealing 1) between the glass preform, which is fed into the furnace, 2) inside the furnace, and 3) between the drawn fibre/preform and the outlet of the furnace body, respectively. So far, there has been no proper way of controlling these seals.

Another type of preform process is MCVD (Modified Chemical Vapour Deposition), where the reactant gases are fed through rotary joints into a substrate tube (a quartz tube) used for producing the quartz part of the glass preform used for making optical fibres. The gases are fed into the MCVD lathe at elevated temperature and, for avoiding condensation problems, the rotary joints have to be heated up to 300° C. or more. The purpose of the rotary joints is to block the spread of process gases to the room atmosphere. An example of a process gas of this kind is chlorine. Further, the ambient air (room air) always contains some water and other impurities, which may cause defects in the product, if they were allowed to contact the substrate tube or the reactant gases inside the MCVD lathes during processing. A typical example of this kind of effect is the well-known attenuation caused by a water peak in the quartz core of an optical fibre.

In the existing MCVD technology, o-rings or ferrofluids are used for sealing the rotary joints to prevent flow of gases from the inside of the lathe to the ambient air. There are a number of problems related to the known technical solutions. Thus, at the harsh conditions of the processing, o-rings do not withstand more than 1-5 process runs and, in case of a leak, the product might be damaged. Ferrofluids are very expensive materials and there are only limited experiences on their use at elevated temperatures.

A third example of a typical preform processing method within the scope of the present invention is the sintering process. This process is used, for example, after an OVD or OVD process for sintering (densification) of the soot into solid material. In this process, the preform is fed through a furnace heating zone, where the sintering take place. For obtaining a more homogeneous result, the preform is rotated, and rotary joints are formed between the parts of the equipment, which are subjected to relative motion with respect to each other. During sintering, the furnace atmosphere is controlled and it might contain harmful gases, like chlorine. Also any water stemming from the ambient atmosphere has to be blocked out. The rotary joints have to work with both axial and rotational movement at the same time. Conventionally, this has been solved by using plates of graphite or other materials and, additionally, by installing a hood around the joint for capturing any C12 molecules. These constructions are unrealiable, they do not block off water well, there is risk that chlorine will emerge into the atmosphere and they will cause the formation of harmful particles in the furnace.

Various mechanical seals are disclosed in JP Published Patent Application No. 55 020260, U.S. Pat. No. 4,477,274, DE Patents Nos. 3 903 466 and 4 006 839, wherein dragging elastomer or graphite seals are described. These seals fit snugly against the preform during drawing of the fibre.

A typical mechanical sealing of the kind mentioned above is also shown in the attached FIG. 2. In the figure, reference numeral 1 stands for the supporting block of the iris, 1.2 designates the clamping ring of a sealing felt (reference numeral 1.3), and number 3 stands for a glass preform and 4 for the furnace body.

Further mechanical sealing constructions comprise suspended quartz plates used for sealing the feed opening.

It has been suggested to rotate the preform about is central axis during fibre drawing. The rotation provides advantages in terms of controllability of the process, evenness of heating, thickness measurement However, any ovality of the preform may—in combination with the dragging seals—impair the rotational movement of the preform and, therefore, also the drawing of the fibre as well as the stretching of the preform. Further, particles released from the polymer or graphite materials may contaminate the fibre.

As mentioned above, seals based on mechanical contact with the preform cause contamination of as well as scratches and other defects on the surface of the preform. Instead of elastomer seals, which chemically are highly durable sealing materials, sealing materials that withstand high temperatures must be used. Typically used seals, which are based on graphite felt (see above) or quartz wool, also allow for penetration of oxygen into the furnace and they are subjected to considerable wear. This can be explained by the fact that there is no return flow from the inside of the heating chamber to the outside through the seal that would resist the diffusion generated, or at least it is very difficult to form such a flow in a porous or not completely tight sealing. A narrow slot, the height of which is on the same order as the free travel of a molecule, can be examined in terms of a vacuum, because a vacuum can be defined a space, where the free travel of the molecule is higher than the distance between the walls. In vacuum, the molecule continues its linear travel between the walls without meeting the oncoming molecule. Thus, an oxygen molecule, for example, that has entered the slot, advances through the slot, once it has gone there. This phenomenon also explains the known fact that molecules are also diffused through a porous wall in the direction of higher pressure. In this light, it is easy to understand that the sealing is either completely tight or it allows a diffusion flow to penetrate, which is difficult to prevent by means of over pressure or other methods. To solve this problem, other means have to be introduced.

In the art, changing the flow of the protective gas has been considered as a solution of the above problem. Thus, U.S. Pat. Nos. 4,174,842, 5,970,083 and 5,897,681 and JP Published Patent Application No. JP 60 081039, for example, suggest increasing the gas flow. By this approach, diffusion of oxygen inside the furnace can be decreased, but the particular problem of this solution is that it considerably increases the consumption and expense of inert gas. In fact, when testing non-contacting solutions, extremely high sealing flows have been employed (over 100 standard litre per minute, in the following abbreviated “SLM”) and small changes in the structural parts of the whole apparatus have caused surprising failures of seals. In some cases, graphite resistances have deliberately been allowed to be destroyed and they have been changed at a few week intervals. This has been used at least in stretching the preform, and the contaminated preform must have then been cleaned separately.

As will become apparent from the above description of the related art, so far there has not been any proper understanding of the overall heating process of or of the importance of a providing a proper distribution of the flow inside a inductive furnace for glass preforms. Furthermore, the sealing solutions of such furnaces have been separately developed based on individual tests of the various parts. Consequently, even small changes, for example, in the diameter of the preform will give rise to a need for a completely new series of tests before the furnace can be taken into operation.

The controllability in all basic types has been made even more difficult by changes in the geometry of the preforms, handlers and substrate tubes, such as changes in the thickness, an oval or bowed shape and deflections.

In some cases, it is sufficient to protect one atmosphere from the influence of the atmosphere on the other side of a sealing/rotary joint. However, in many cases there is great need for separating the atmospheres from each other and this aim has also to be performed by the sealing.

As explained above, the difficulties mentioned above are aggravated, when the preform is rotated during the process.

### SUMMARY OF THE INVENTION

It is an object of the present invention to eliminate the drawbacks of the known technology and to provide a new solution for sealing furnaces used in drawing of optical fibres and stretching of glass preforms and similar operations related to the manufacture of optical fibres.

The invention is based on the idea of maintaining the concentration of gaseous impurities in the heating oven essentially on the same level as the concentration of the same impurities in the inert gas fed into the oven. Further, there is then established a diffusion barrier against the inflow of undesired gaseous components from the ambient air, driven by the forces of diffusion, by generating a barrier flow of inert gas in the inlet opening of the heating oven, said barrier flow having a direction of flow, which is generally opposite to the direction of the diffusion. Thus, in an apparatus according to the present invention, there is formed at least one, preferably as many diffusion barrier zones as there are openings in the furnace chamber. The diffusion barrier will allow the penetration of impurities only in an amount, which will not essentially increase the concentration of impurities in the furnace. Such an increase is preferably less than 10%, in particular less than 5%, of the concentration due to the presence of impurities in the protective gas fed into the furnace.

It is possible to make a two-way construction based on the above basic concept. Thus, in a heat processing equipment used in production and processing of preforms for optical fibres, there can be one barrier flow preventing process gases from escaping (diffusing) out of the furnace and another barrier flow preventing ambient atmosphere gases from diffusing into the furnace.

This technical solution is, in particular, carried out first by the invention in a method of subjecting a glass preform (work piece) to processing by tensile forces in a furnace to produce a glass product of predetermined shape, wherein at least a part of the glass pre-form is introduced into the heating oven through an inlet opening, a portion of the glass preform introduced into the heating oven is heated to above the softening point of the glass, the heated portion of the glass preform is subjected to tensile forces in a drawing direction to process the preform into the predetermined shape, the processed portion of the preform having the predetermined shape is drawn from the furnace through an outlet opening, and the softening portion of the preform and at least a part of the processed portion of the preform are flushed in the furnace with inert gas fed into the furnace through a feed opening.

Generally, the process can be applied to any heat treatment process of glass substrates, by forming a diffusion barrier in at least one gas conduit interconnecting the gas space inside the heat treatment device with the ambient atmosphere to seal off the conduit against flow of gas in at least one direction through the conduit.

In addition to the embodiment discussed in detail above, the general method can be carried out in connection with the feeding of process gases into a rotating substrate tube used for producing MCVD preforms. The technical solution can, also, be performed as a manner of sealing off process gases and ambient air when sintering soot processed preforms.

More specifically, the processes according to the present invention is mainly characterized by what is stated in the characterizing parts of claims 1 and 28.

The apparatus according to the invention is characterized by what is stated in the characterizing part of claim 17.

The present invention provides considerable advantages. Thus, the solution according to the invention can be used in the manufacture of optical fibre, such as MCVD, PVD, stretching, collapsing, sintering, sleeving of glass blanks, which in the following are also called “preforms”, in the processes mentioned above and in various furnaces needed for their combination processes and in a fibre drawing furnace. The invention can be used to provide non-contacting sealing, the consumption of protective gas can be optimised and the number of exact parts minimized by the method described in the invention and, furthermore, it enables simultaneous rotation of the preform. It can be one way or two direction type and it can be used at all temperatures as well as with all gases. The protective gas can be inert or active but it has to be suitable for the specific case. The invention combines and integrates the gas feeding system, the washing or flushing flow of the furnace, the chimney effect, the upper opening (also called the “upper iris”, the lower opening (also called the “lower iris”, and their physical dimensions.

Thus, the effect of any changes in one part of the whole can be observed and, correspondingly, compensated for in the other parts of the system or by changing the operation or flow distribution or gas feed points of the apparatus. As a result, the number of practical training cycles needed also decreases considerably.

The solution according to the invention provides at least the following advantages: In combination: non-contacting sealing and use of perform rotation especially in graphite furnaces. The invention will increase the working life of the furnace, in particular or the graphite resistances, and it will reduce the need for regular maintenance of the furnace. In view of the fact that there is less dust and powder (particles) formed by oxidation of the graphite resistances, cleanliness will grow. Importantly, the consumption of protective gas will be decreased compared to the present technical solutions. The flow directions can be changed as desired and the constructional parts of the equipment can be made simple and loosely fitting allowing for a wide variation of the dimensioning.

Furthermore, the invention will provide for transfer of impurities, which are obtained by a selection of the chimney effect, the distribution of flow carried out by means of conductance and the feed point of the protective gas, to an area that is more advantageous for the end product. Below are disclosed various methods of calculating the number of flows, of calculating the chimney effect, of calculating the flow rates and directions in the aggregates. These can be efficiently utilized for the design on new equipment for processing of performs both during stretching and during fibre drawing. The methods allow for dimensioning of the gas feed nozzles.

The present invention discloses methods of defining the velocity of the sealing flow required by the diffusion for each level of cleanliness and sealing distance, as well as methods for dimensioning the aggregates and flows by using the methods mentioned above.

By using the present invention the gas flows can be designed to separate two gas volumes from each other not only in stationary system but also—and importantly, when there are rotation-, axial- and radial movements involved.

### BRIEF DESCRIPTION OF THE DRAWINGS

In the following, the invention will be examined in detail with the aid of a detailed description and with reference to the appended drawings.

FIG. 1 shows in a schematic fashion the side-view of a process furnace with a preform and its key parts;

FIG. 2 shows a similar side-view of the cross-section of a typical modem solution for sealing the furnace;

FIG. 3 shows the cross-section of a sealing situation implemented according to the invention;

FIG. 4 shows in side-view the advance of a diffusion barrier;

FIG. 5 shows the distribution of a flow of protective gas in a cold furnace or in a horizontal furnace (simple case with one feeding point; c1, c2 and c3 can comprise several subconductances);

FIG. 6 shows a gas flow caused by the chimney effect;

FIG. 7 shows combined duct flows and protective gas flows;

FIG. 8 shows some iris solutions according to the invention;

FIG. 9 shows a preferred embodiment of the invention;

FIG. 10 shows a horizontal section of the embodiment of the previous drawing;

FIG. 11 shows in a schematic fashion the basic flows involved with a chimney effect;

FIG. 12 shows in a schematic fashion the intermediate stage of a process for stretching of a preform

FIG. 13 shows the phase in which the handler of the preform is shoved inside the furnace,

FIG. 14 shows the end phase of the process, in which sealing occurs between the handler and the collar,

FIG. 15 shows in a schematic fashion in sideview the cross-section of a rotary joint construction for MCVD/PVD substrate tube, and

FIG. 16 gives a similar view of a joint for a sintering furnace.

### DETAILED DESCRIPTION OF THE INVENTION

As discussed above, in the solution according to the invention, any unwanted gaseous molecule contents can be kept outside a volume (e.g., a furnace) by using a flow of inert gas to form a diffusion seal. According to the invention, the content of residual is accepted to correspond essentially to (e.g. being slightly in excess of) the level of impurity of the protective gas, for example, and a sealing flow opposite to the diffusion is arranged by means of the sealing flow, forming a sufficient diffusion seal by means of the sealing distance used. The target concentration of the impurities is typically less than 100 ppm, in particular about 1 to 90 ppm, which can correspond to an excess of 10%, preferably 5%, or less of the concentration of impurities in the protective gas.

The protective gas used in the present invention can be any inert gas, which is lighter or heavier than air. Typically nitrogen is employed. Argon is more expensive, but it has been found that the consumption of the argon gas is smaller than of nitrogen, which will compensate at least to some extent for the added cost of the gas. Argon has a higher density than air and it will therefore more efficiently revert the chimney flow, as will be explained below.

Various technical gases and gas mixtures, such as air, which has been deoxygenized, can also be employed. It is important that the sealing gas (or gas mixture) does not harm protected gas volumes (at MCVD the gas can be O2).

The invention comprises a furnace assembly having aggregates, which use flows and structural parts that are designed so that the distribution of gases is taken into account in the proportions of conductances, non-contacting sealing by means of a diffusion barrier (sealing condition), possible flow rate and direction of flow over the aggregate conductances, provided by a chimney effect, and combining the above-mentioned flows to define the sealing distances needed. By selecting the actual feed point, it is also possible to control the formation of diffusion barriers in the furnace.

As will be explained in more detail below, it is particularly advantageous to design the apparatus in such a way that the opening inlet—in particular the upper opening has a diameter which essentially corresponds to the diameter of the furnace tube (the graphite tube).

In practice, and as will be examined in more detail below, it is preferable that in a vertical furnace, the lower iris (lower inlet opening) is wider than the upper iris (a higher conductance). In that case, the upper iris mainly defines the volume of the duct flow (a hatch), and the sealing flow of the lower iris is defined so that it forms a sufficient sealing at the set dimensions. The sealing condition in the upper iris must also be valid, but the duct flow added into the upward component of the protective gas flow is generally so big that the sealing condition is valid for constructions that are sufficiently constricting. For example, the slot of the upper iris should be on a preform of 0.1 to 10 mm, in order for the chimney effect to be suitable. A sealing distance of about 0.5 to 100 mm with reasonable flow levels seems to be enough for the lower iris.

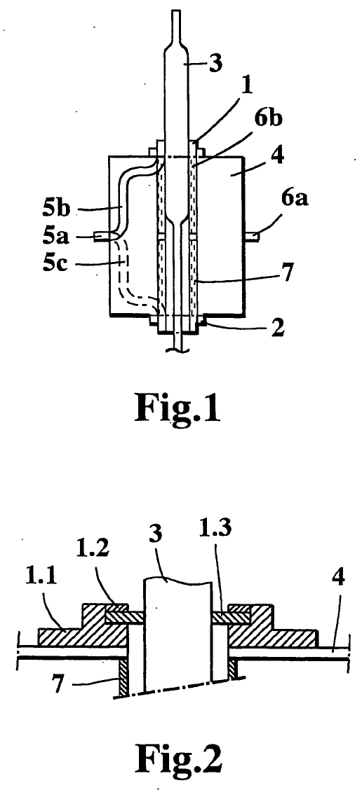

A first preferred embodiment of the invention is shown in FIG. 1, in which the following reference numerals are used:
1. upper iris
2. lower iris
3. preform having a generally tapered shaped towards one of its end, that end being positioned upwards or downwards,
4. oven chamber
5a gas inlet of the protective gas
5b gas inlet piping of the protective gas
5c feed piping of the protective gas
6a outlet of the gas flush flow of the oven
6b nozzle for the flush gas for feeding gas inside the oven tube
7 oven tube

In the construction according to the figure, which construction can also be positioned in other directions, such as horizontally, the nozzles of the furnace (or “heating oven”), marked with reference numerals 1, 2, 5 and 7, have been dimensioned such that a diffusion barrier flow is formed in each of them to warrant for sufficient purity. The calculation of the rate of this diffusion barrier flow and the required length of the barrier distances will be discussed below.

The actual furnace space is formed by an inner portion of the furnace heating tube 7, wherein the part of the preform, which is to be heated, is positioned. The oven heating tube 7 is typically manufactured from graphite and it is heated by means of electric current. This electric current comprises current generated either by induction or by galvanic coupling. The intermediate space between the oven heating tube 7 and the oven chamber 4 is reserved for insulation and, in the case of an induction oven, also for an induction coil. The oven chamber 4 is typically water-cooled.

Protective gas is fed into the oven via nozzle 5a, from which it is further conducted via nozzle 5b to the desired location within the oven. The gas can also be fed through the iris construction or it can be fed at several positions 5b, 5c etc., the gas flow. being split up at predetermined ratios, through one or more feed nozzles 5a. It is important that the purified protective gas is conducted directly into the oven tube 7 so that any dust released from the insulation would be directed away from the sensitive perform (/or optical fibre) 3. By proper selection of the feed point(s) of the protective gas it becomes possible to influence the direction and the rate of the gas flow within the oven tube and in the various parts of the oven tube. We have found that by proper adjustment of the rate and flow of the gas, the flow at the centre of the oven tube (the hot zone) can be minimized or even close to zero, if so desired. In the simplified flow model, which is to be presented later, the location of the inlet feed is not considered, but it can easily be added therein.

By proper distribution of the gas flows within the furnace it becomes possible to change the gas consumption. Preferably, at least 5% of the mass flow of the gas is directed downwards, in particular at least 50%.

The gas flows can be split up in different sub-flows outside the furnace, e.g. using various mass flow regulators.

The outflow of gas from the oven is typically accomplished by allowing a part of the gas to leak through the joints in and between the furnace tubes 7 (or through openings made in the furnace tubes) into the intermediate space. This flow can be enhanced by partially evacuating the intermediate space via nozzle 6a. This procedure is in use in particular during flushing of the intermediate space before heat-processing in order to remove oxygen and moisture from the oven. During the processing the intermediate space is not flushed. The flushing can be made more effective by creating a distinct flow route, e.g. by a nozzle 6b made in the oven tube and by fitting the gas outlet nozzle 6a at a position where there are left no pockets which are difficult to flush. Using a construction of this kind, the rate and the distribution of the gas flow within the oven is not dependent on the operation parameters. At the same time, it becomes easier to find the right rates of the gas flows when the various conductances are clearly defined. If desired, it is possible to provide suction at the outlet, having a flow rate, which can be adjusted to a desired level by using a mass flow regulator and the gas flow route is determined by vias formed in the construction. The purging can be carried out also with a separate feed nozzle, which is directly connected to the interstitial space.

By this arrangement it becomes, on one hand, possible to obtain efficient flushing of the intermediate space and, on the other hand, to transport any particles away from the preform. The gas does not either cool the furnace chamber.

It is of particular importance that, with the exception of the above mentioned vias and nozzles, the furnace is gas-tight, so as not to allow oxygen to penetrate into the furnace chamber. The flow rate of the protective gas fed into the oven with the mass flow regulator, as well as the flow rate of the flushing gas withdrawn from the intermediate space of the oven, adjusted with the mass flow regulator, then the flow distribution for the upper and lower irises are exactly known as well as the barrier flows provided thereby.

A furnace provided with properly working diffusion barriers, the oxygen, which deteriorates the graphite parts of the furnaces primarily stems from the carrier gas. It is therefore important to minimize the volume of gas fed into the furnace and to use clean and pure gas for feed through the furnace chamber.

The processed product comprises preferably an optical fibre or a stretched preform. The processed product is preferably continuously, typically during stretching at various drawing speeds, drawn from the furnace.

As will become apparent from the below description of a preferred embodiment, the upper opening can be formed by a graphite tube or a tube made of quartz. The advantage of the latter is that it is inert, whereas the former can be made as a sacrificial substrate which will react with any oxygen before it enters the furnace. The graphite tube also allows for some dragging contact with the surface of the preform.

The sealing is a barrier zone exhibiting essentially laminar flow conditions of the gas. Therefore it is arranged above the feed nozzles of the protective gas. If the nozzles are fitted at the upper opening, a free flow path upwards of about 10 mm and more is preferred. Lengths of about 15 to 1000 mm are possible. By length is meant a length in the direction of the central axis of the furnace tube. The barrier zone is defined by the clearance between the glass preform and the opening of the furnace. The difference between the external diameter of the glass preform and inner diameter of the opening is typically in the range of 0.5 to 15 mm

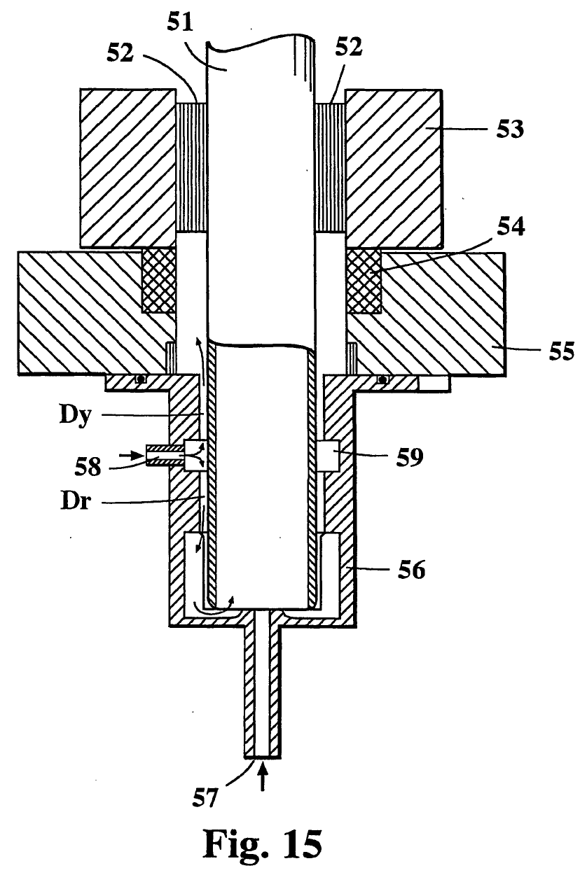

A second example is given in FIG. 15, which shows the rotary joint construction for a MCVD/PVD lathe. In the figure, the following reference signs are used:
51. Rotating glass tube
52. Chuck jaws
53. Chuck
54. Bearing (between chuck and the reactor body)
55. Part of reactor body
56. Barrier zone
57. Feed tube of process gas
58. Feed tube for barrier gas
59. Gas distribution ring
Dr diffusion barrier to gases coming from the reaction space
Dy diffusion barrier to ambient gases

In the technical solution according to the example, a glass tube 51 is fed through the jaws 52 which are opened at the bottom of the barrier zone 56. The jaws are close and the tube centered such that a coaxial slit and a gas distribution ring 59 are formed between the tube and the barrier zone. At the end of the barrier zone, gas flow channels have been formed in such a way that the glass tube does not prevent the flow of gas according to the arrows. The gas flowing through Dy is allowed to exit, e.g. passed the jaws. When the tube is arranged for rotation, the only point of contact is at the lubricated bearings 54 of the chuck 53. In the rotary joint between parts 51 and 56 is no contact. Since part 56 is not rotating, the process gas feed nozzle 57 can be equipped with a normal tube fitting. The temperature of the rotary joint thus accomplished is only limited by the limitation normally placed on the constructional parts of the joint. Thus, if part 56 is made of quartz, the operational temperature of the joint can be as high as 1700° C.

The diffusion barrier is accomplished by feeding gas needed for the forming of the barrier through the feed tube 58. This gas can be a gas, which is inert with regard to the reaction or which is of such a kind that small fluctuations in its concentration do not essentially influence the process. Arriving at the gas distribution ring, which is loose in conductivity compared to the additive conductances of Dy and Dr, the gas is distributed generally along the periphery of the ring. From this integral periphery the gas is divided into the coaxial slits Dy and Dr depending on their ratio. The conductances of both slits are dimensioned in such a way that there is a barrier formed in them (in accordance with the level of purity selected for them—the level can be, e.g., on the order of ppm's or ppb's). The barrier state comprises a flow which depending on the dimensions of the flow channel allows only for a ppm of the molecular concentration on “downstream” of the barrier to reach the gas distribution ring.

When we examine the operation of the diffusion barrier it should be noted that a tight sealing is formed from two interconnected diffusion barriers, which act in different—preferably opposite—directions. One of the barriers seals the apparatus externally and the other internally. It is possible to assign different requirements for purity for the barriers and, thus, to optimize the gas consumption in respect to the critical direction of flow. By increasing the “safety margin” or by making the feed pressure constant, the barrier can be designed for proper operation using tubes having any diameter within a predetermined range. The smaller the acceptable variation, the smaller are the slits, which are needed and the less gas is consumed for providing the barrier. It is possible, alternatively, to reduce the size of the slit or to increase the flow to increase the feed pressure of the gas through the barriers, whereby the operation of the barrier is no longer pressure dependent. The pressure difference between the outside of the tube and the inside of the tube can also be compensated for by controlling the conductance ratio of the slits. This adjustment can be made by changing the dimensions of the slits (height, wideness and length).

It is further possible to use a connector piece, a metal tube being attached, e.g. to the glass via an elastomeric seal and then this metal tube is fitted inside the part 56, in this case a glass tube. Thereby, a small gas consumption is reached (the clearance between 51 and 56 are small) and a large variance of the tube sizes in the same construction.

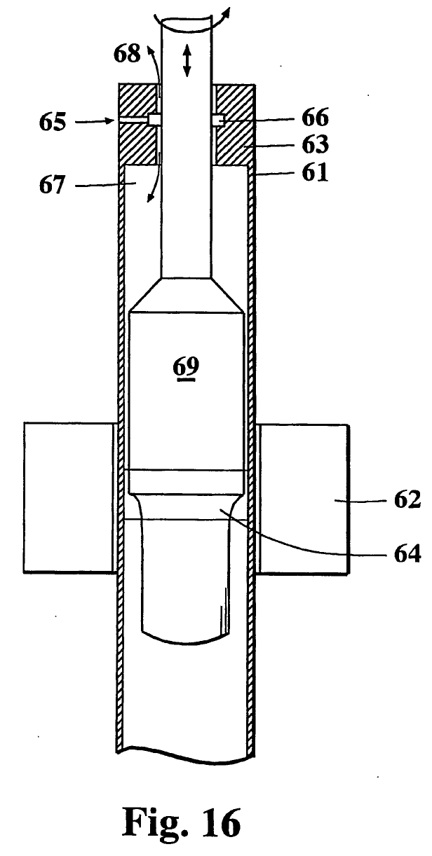

A third example is shown in FIG. 16, which depicts a part of a sintering furnace, comprising a furnace tube 61, a furnace 62 for heating, an inlet for process gases 63. The preform 69 is introduced from above into the furnace tube and sintering takes place in the sintering zone 64. A rotary joint being formed at the neck, when the preform is being rotated. The barrier gas fed through nozzle 65 is divided into two flows 67 and 68; one from barrier gas distribution ring 66 towards room atmosphere and second from barrier gas distribution ring towards process gas volume. Both flows are adjusted to form protective barrier flow to prevent air reaching the barrier gas distribution ring and on the other hand prevent process gases reaching the distribution ring 66. This type of construction can be constructed many different ways and it works as well by using suction instead of feeding gas to the barrier gas distribution ring. One aim is to achieve a situation where there are two opposite flow, which have adjusted to form protective diffusion barrier like described in the present invention in further detail below.

Dimensioning of the Construction According to the Present Invention

Diffusion Barrier

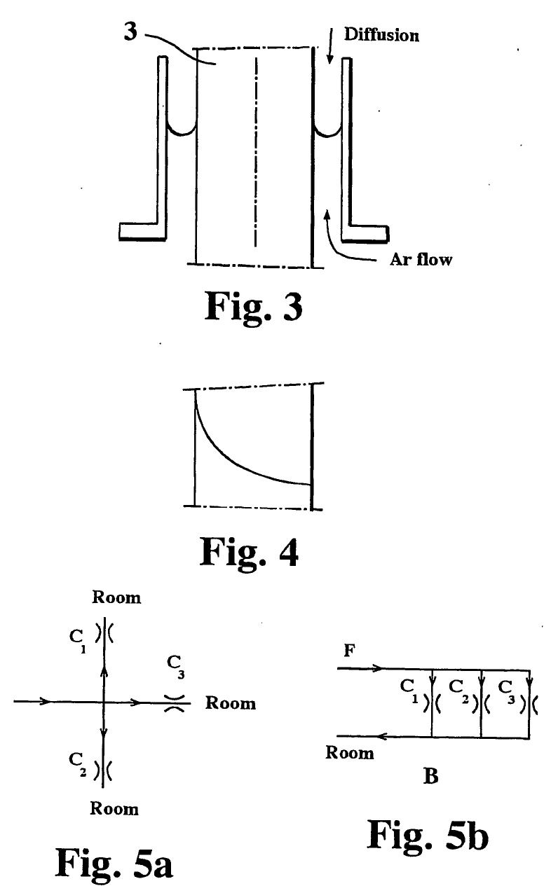

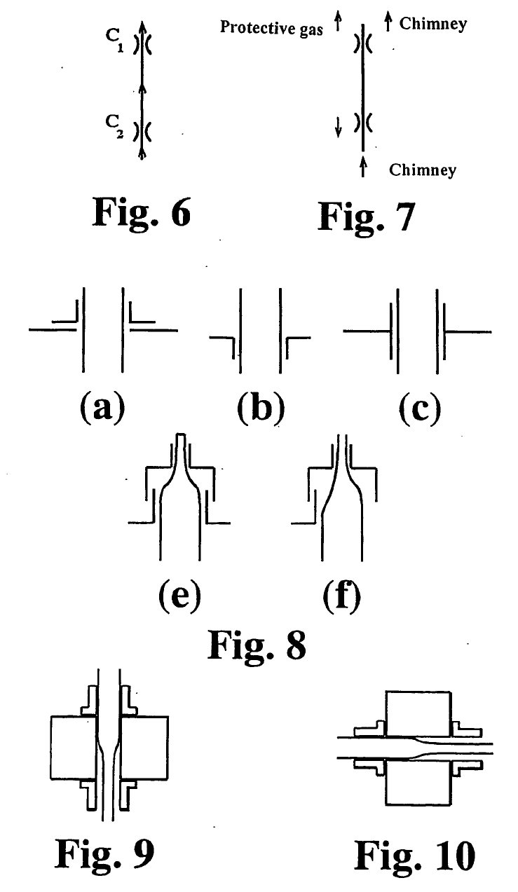

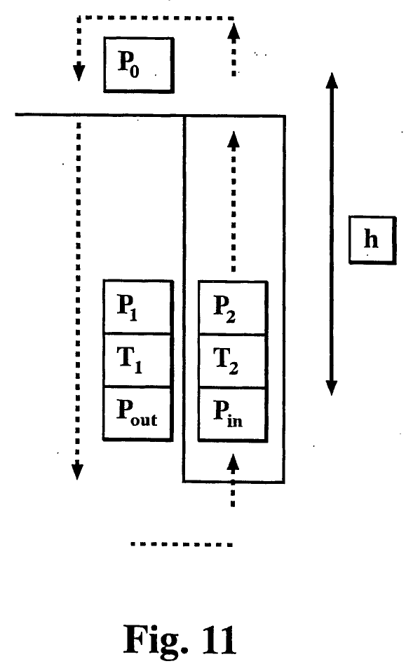

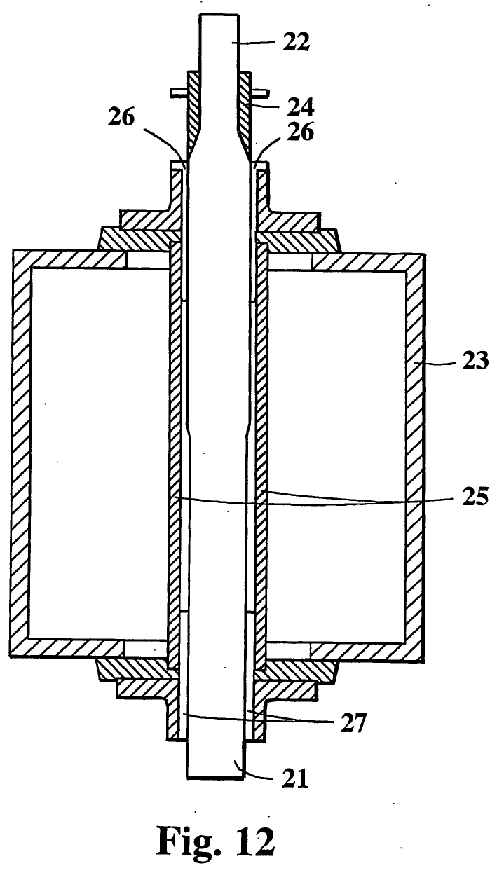

I FIG. 3, the flowing pattern in the iris is disclosed. A similar barrier flow can be used in other external and internal inlets and outlets according to the invention. The present invention aims at preventing the flow of undesired gas molecules via the inlet (e.g. into the oven). The prerequisite of the dimensioning is that an inflow having a tolerable level of impurities is allowed. Complete purity is not an aim. Such an acceptable level is the concentration of impurities in the inert protective gas (used for producing a barrier flow) or a fraction (e.g. a tenth part) thereof. On the other hand, the effectiveness of the barrier is also influenced by the barrier distance available. The barrier flow can be calculated from the cross-section of the opening and the volume flow of the barrier flow.

The diffusion barrier conditions can be calculated as follows:

Equations for gas iris design

1) Stationary Medium:

Fick's diffusion law in one dimension for concentration C(x,t):

$$\frac{\partial C ( x , t )}{\partial t} = D \frac{{\partial }^{2} C ( x , t )}{\partial {x}^{2}}$$

States that the time derivative of concentration equals the second spatial derivative of the concentration multiplied by a constant D. Constant D is defined as the material diffusion constant, [D]=[m²/s].

Consider a boundary at x=0, with negative x-values at left hand side and positive values at right. Assuming constant concentration Cₛ at left hand side, and initially (t=0) zero concentration at right side, the solution of Fick's diffusion equation would be

$$C ( x , t ) = {C}_{s} , x < 0$$

$$C ( x , t ) = {C}_{s} [ 1 - erf ( \frac{x}{2 \sqrt{Dt}} ) ] , x \geq 0$$

This means that when the time of observation t goes to infinity (erf(0)=0), concentration reaches Cₛ thoughout the space.

2) Moving Medium:

In a gas iris the diffusion flow is suppressed by an opposing flow of the medium. Continuing with the above example the medium would flow from right to left in order to counterbalance the diffusion flow.

Fick's law for a moving medium has an additional term in the right side of the equation,

$$\frac{\partial C ( x , t )}{\partial t} = D \frac{{\partial }^{2} C ( x , t )}{\partial {x}^{2}} + v \frac{\partial C ( x , t )}{\partial x}$$

where v is (the magnitude of) the velocity of the medium flowing from right to left. The effect of the additional term is to reduce the concentration the more the velocity v is. Note that the concentration decreases to the right, and the sign of the spatial derivative of C(x,t) is negative.

Trial function of the form

$$C ( x , t ) = {C}_{s} [ 1 - erf ( \frac{x + vt}{2 \sqrt{Dt}} ) ]$$

Satisfies the Fick's equation for moving medium.

Another, time independent trial function of the form

$$C ( x , t ) = {C}_{s} \cdot {ⅇ}^{- ( \frac{v}{D} ) x}$$

satisfies Fick's equation also.

For curiosity, yet another solution exists, namely

$$C ( x , t ) = {C}_{s} \cdot {ⅇ}^{+ ( \frac{v}{D} ) ( x + 2 vt )}$$

However, this one goes to infinity as time t evolves, so that the solution is excluded as unphysical.

The general trial function is found by superposing the trial functions above,

$$C ( x , t ) = {C}_{1} ( t ) [ 1 - erf ( \frac{x + vt}{2 \sqrt{Dt}} ) ] + {C}_{2} ( t ) \cdot {ⅇ}^{- ( \frac{v}{D} ) x}$$

$$where$$

$${C}_{1} ( t ) + {C}_{2} ( t ) = {C}_{s}$$

The time dependence of the solution depends on the error function argument

$$Arg = \frac{x + vt}{2 \sqrt{Dt}}$$

Time derivative of the argument is

$$\frac{\partial Arg}{\partial t} = \frac{\partial }{\partial t} ( \frac{x + vt}{2 \sqrt{Dt}} ) = - \frac{x}{4 t \sqrt{Dt}} + \frac{v}{4 \sqrt{Dt}}$$

which goes zero when time t satisfies the condition

$$v = \frac{x}{t}$$

Thus, if the velocity v is constant, there will always be a moment in time t=t₀, that at any point x the error function argument has a maximum value. When time goes on, the argument will decrease until it finally goes zero with infinite t.

Thus, for infinite t, the solution is reduced to the time independent term

$$C ( x , t = ∞ ) = {C}_{s} {ⅇ}^{- \frac{v}{D} x}$$

Considering a gas iris of length L, the stationary condition states that the concentration behind the gas iris will be

$$C ( L , t = ∞ ) = {C}_{s} {ⅇ}^{- \frac{v}{D} L}$$

So that the sealing efficiency of the iris E is

$$E = \frac{{C}_{s}}{C ( L , t = ∞ )} = {ⅇ}^{+ \frac{v}{D} L}$$

From the above it is seen that the sealing efficiency rises exponentially with increasing medium velocity v or iris length L.

The iris length L is obtained from the exponential equation above:

$$L = \frac{D}{v} ln ( \frac{{C}_{s}}{C ( L , t = ∞ )} ) \qquad ( equation 1 )$$

6.2.2 Distribution of the Protective Gas Flow

In FIG. 5a, the distribution of the gas flow (F) in the conductances of the upper iris (C1), the lower iris (C2) and the purge flow of the intermittent space (C3) is shown. When the gases flow into the same room, the same feature can be shown as the flow system according to FIG. 5b. In a system of this kind, the flow is distributed directly in the ratio of the conductances, which means that, for example, the flow of the upper iris (F1) is:
F1=F*C1/(C1+C2+C3). (2)

The other flows can be calculated in a similar fashion.

The conductances can, for their part, be calculated from the following equation:
C=K W*Hˆ3/L, wherein (3)
C stands for conductance
K is a coefficient
W is the width of the slit
H is the height of the slit
L is the length of the slit

By considering the geometrical dimensions of the inlets and outlets, the flow velocity in each inlet can readily be calculated and inserted into the equation (1) derived in paragraph 6.2.1. By comparing the barrier length of a physical specimen with the barrier length given by the equation it is easy to determine whether the barrier flow is sufficient or whether it should be altered.

From equation (1) it can also be seen that by increasing the length of the barrier slit, the barrier flow needed can be reduced even if it becomes apparent from equation (3) that the conductance increases. By reducing the height of the slit, the flow rate can be increased whereby also a lower flow rate of the barrier gas is needed. This influences conductance to the third potential, equation (3).

When we examine the equation of the gas flow distribution (2) we note that the calcuation has be made by iteration because a change in the dimensions of the nozzle (e.g. the iris) will also have an impact on its conductances and thereby on the distribution of the flow over the various conductances. This, on the other hand, changes the flow velocity of the gas fed through the slit and therefore also has a bearing on the required length of the barrier path. One easy way of performing the iterative calculation comprises the use of table calculation.

Chimney Effect

When the furnace is placed in vertical position and when it is warm, a chimney effect based on buoyancy will be generated in the furnace tube. This effect can be calculated as explained in the following (reference is also made to FIG. 10):

A tube of height h is kept at temperature T₂. The surrounding air is at temperature T₁. Air pressure at the tube exit level (reference level) is p₀. The pressure at depth h below the reference level depends linearly on depth h and gas density p such that outside the tube at depth h,
pₒᵤₜ=p₀+ρ₁·g·h
where g=9.81 m/s² is the gravitational acceleration constant. Inside the tube at level h,
pᵢₙ=p₀+ρ₁·g·h

The pressure difference at level h, Δpₕ, is thus
Δpₕ=g·h·(ρ₁−ρ₂)

Density ρ, temperature T, and pressure p are related together for ideal gases by

$$p = \frac{{n}_{mol}}{V} \cdot R \cdot T = \frac{{n}_{kpl}}{V} \cdot k \cdot T = \frac{ρ}{M} \cdot k \cdot T = \frac{ρ}{{M}_{mol}} \cdot R \cdot T$$

For argon gas (Ar), molar weight is Mₘₒₗ (Ar)=40 g/mol and for nitrogen gas, Mₘₒₗ(N₂)=28 g/mol. For air,

Mₘₒₗ(air)=29 g/mol. M is the gas molecular weight.

R is the molar gas constant, R=8.314510 J-mol⁻¹−K⁻¹ (=0.08314510 bar dm³ mol⁻¹−K⁻¹).

k is the Boltzmann constant, k=1.380658·10⁻²³ J/K. R and k are related together by the

$$k = \frac{R}{{N}_{a}}$$

Avogadro constant Nₐ, such that

Nₐ=6.0221367·10²³/mol.

Ideal gas density [kg/m³] is thus

$$ρ = \frac{p \cdot {M}_{mol}}{R \cdot T} = \frac{p \cdot M}{k \cdot T}$$

If the gas is heated from temperature T₁ to temperature T₂ while keeping the pressure p constant, its density is reduced accordingly,

$$\frac{ρ ( {T}_{2} )}{ρ ( {T}_{1} )} {\vert}_{p} = \frac{\frac{p \cdot {M}_{mol}}{R \cdot {T}_{2}}}{\frac{p \cdot {M}_{mol}}{R \cdot {T}_{1}}} = \frac{{T}_{1}}{{T}_{2}} ⇔ Δρ = ρ ( {T}_{2} ) - ρ ( {T}_{1} ) = ( \frac{{T}_{1}}{{T}_{2}} - 1 ) \cdot ρ ( {T}_{1} )$$

The overall pressure difference induced by a heating-cooling cycle at the bottom level of the chimney is obtained by substituting density difference equation to the pressure difference equation above,

$$Δ p = g \cdot h \cdot ( ρ ( {T}_{2} ) - ρ ( {T}_{1} ) ) = g \cdot h \cdot ( \frac{{T}_{2}}{{T}_{1}} - 1 ) \cdot ρ ( {T}_{1} ) \qquad ( Equation 4 )$$

The pressure difference can be calculated by inserting the temperature of the furnace and the dimensions thereof into equation 4.

It should be noted from equation 4 that if a gas having a density higher than air is used, then the direction of flow of the protective gas is directed downward. As a result, the gas has to be heated to a temperature higher than about 400 K, at which temperature the chimney flow will turn upwards. This, at the same time means that, at the temperatures mentioned, the mass flow of protective gas needed for reverting the chimney flow is reduced.

When the matter is studied based on the depiction in FIG. 6, it can be noted that the pressure difference strives at providing a flow through the conductance of the upper iris (C1 and the conductance of the lower iris (C2). In this example, the conductance of the furnace tube has not been considered because it has been estimated to be of such a magnitude that it bears no influence on the formation of diffusion barriers in the openings. It would, however, be rather straightforward to consider it. The chimney flow can be calculated by using the following equation
1/Ctot=1/C1+1/C2 (5)
for the cumulative effect of serial conductances and
Fh=Ctot(P1ˆ2−Poˆ2) (6)
for the chimney flow, wherein
Ctot is the toal conductance and
Fh is the chimney flow
Po is the air pressure
P1 on the sum of the air pressure and the chimney effect

Since the chimney effect is directed upwards, the chimney flow has to be added to the flow directed through the upper iris. Correspondingly, it has to be reduced from the flow directed through the lower iris, because is weakens that flow. These features are illustrated in FIG. 7. The rate of the chimney flow is usually significant compared to the barrier flows, which means that it is possible easily to obtain a situation where there is formed a diffusion barrier at the upper iris. The problem to be solved is therefore rather how to create a situation in which the flow rates are sufficiently large to generate a diffusion barrier also at the lower iris.

It can be assumed, when looking at the situation more generally, that the required volume flow of protective gas is such that it is sufficient to cover the chimney flow through the upper iris. In addition to that volume, further flow of protective gas should be sufficient also to form a diffusion barrier—when the flow is divided according to equation 2—also at the lower iris (the flow through the upper iris increses also as shown by equation 2. In such a case, it is preferred to construct the lower iris with a larger clearance between the preform (or optical fibre) and inside of the opening to allow for a greater flow of protective gas to direct the major part, preferably at least 60 volume-%, in particular at least 70 volume-%, of the additional flow downwards. Similarly, it can be deducted from equation 1 that a reduction of the barrier length and the flow slit (increase of flow rate) will reduce the amount of necessary barrier flow. The limit will be reached when the conductance at the lower iris becomes too small (i.e. when a greater part of the flow is directed to the upper iris). Also the slit between the preform and the furnace tube 7 is a conductance, whereby it has to be considered when dimensioning flow rates and volumes. By transferring the feed point from the upper opening towards the lower opening, the ratio between the conductances directed upwards and downwards, respectively, whereby the feed rate for annulling the chimney flow is reduced. The gas consumption is then decreased.

In practice, it can be said that the conductance of the lower iris should be greater than that of the upper iris. On the other hand, the flow needed for creating a diffusion barrier is rather small (only a few SLW compared to the chimney flow when a barrier length of some 1 to 5 cm is arranged at the lower iris. Then, the clearance at the lower iris can be considerable, which facilitates operation of the equipment. This arrangement becomes particularly advantageous when drawing is made upwards, because it becomes possible to leave ample space for a preform, which is of imperfect shape and, e.g., having bowing and bumps on the surface, whereas the drawn or stretched elongated product, which has a much more exactly defined shape, will pass through the furnace opening at the upper iris, where the clearance should be smaller to allow for a proper diffusion barrier.

As a good rule of thumb, a flow rate comprising the chimney flow+5 SLM can be mentioned. If necessary, the feed can be increase somewhat to allow for a volume sufficient for flushing of the intermediate space. When a lower opening having an inner diameter of 80 mm and a length of 100 mm, a flow on the above order is sufficient. This flow volume has to be added to the chimney flow which, depending on the density of the gas, the temperature, the total conductance and the length of the furnace, is on the order of about 5-100 SLM.

The difference between the external diameter of the preform and the inner diameter of the upper opening is preferably about 1-15 mm, and the length of the zone formed above the feed nozzles for the protective gas—providing a zone of laminar gas flow—is about 10 mm to 1000 mm, preferably about 15-150 mm.

In the above-described situation the upper iris works as a throttle and the flow through it is so large that it is easy to meet the diffusion barrier condition. Similarly, in the lower iris end of the furnace, primarily care has to be taken to see that the diffusion barrier condition is met.

The chimney flow can easily be added to the distribution equations of the inert gas for instance by table calculation. It is good to note that changes in the dimensions of the irises also influence the magnitude of the chimney flow. Therefore, a change of one part, influences the whole flow system. It is difficult to see these contrary effects, they always have to be calculated when any changes are to be implemented in the system.

Finally, in horizontally placed furnaces, the chimney effect need not be considered. In vertical furnaces it is of significance already at a temperature of 500° C.

The apparatus according to the invention has been used for the stretching of preforms in the following manner:

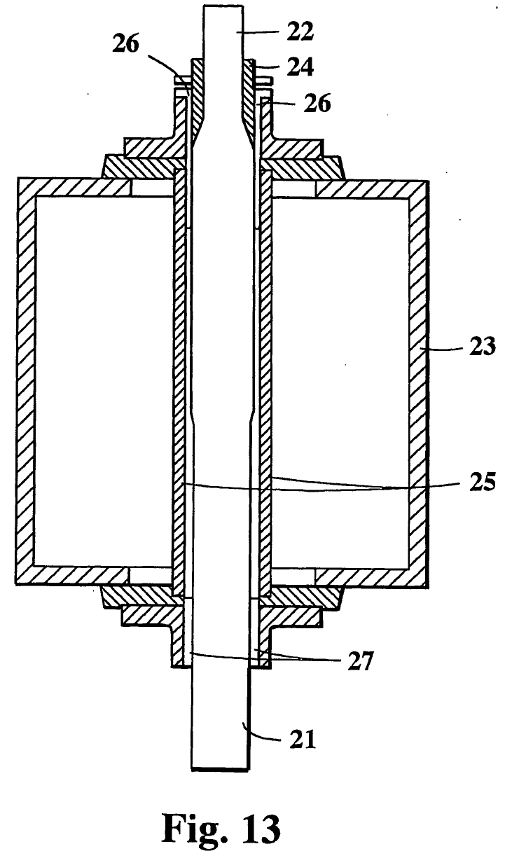

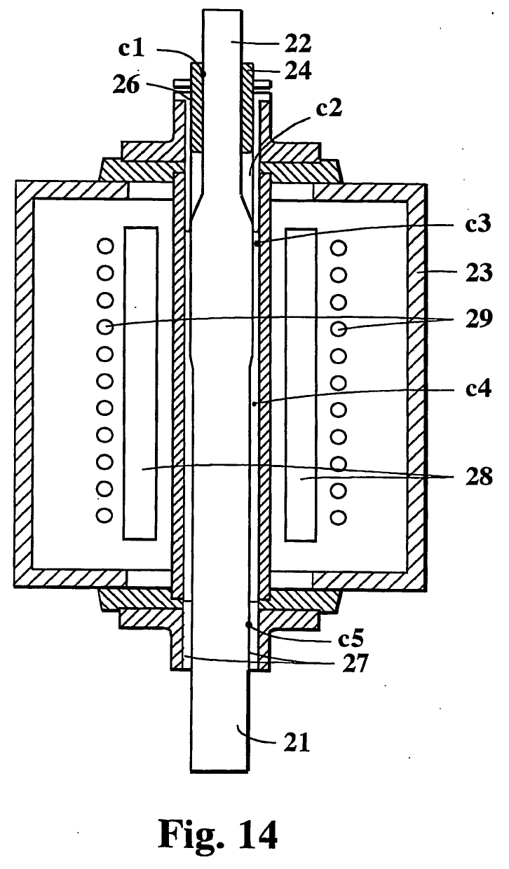

FIG. 12 shows the intermediate stage of the process, FIG. 13 shows a phase in which the handler 22 of the preform 21 moves inside the furnace 23, and FIG. 14 shows the end phase of the process in which sealing occurs between the handler 22 and the collar 24. The following reference numerals are used: Preform 21, handler 22, furnace wall 23, collar 24, graphite tube 25, upper diffusion barrier zone 26, lower diffusion barrier zone 27 (in FIG. 14: porous graphite block 28, heating coil 29).

The apparatus has been designed in such a way that a seal is formed by the slit between the preform and the inner wall of the inlet opening. Since the preform does not contact with the furnace, it can be rotated, if so desired.

Towards the end of the process, the handler is moving into the sealing zone, at which stage the seal is formed by the slit between the perimeter of the perform and the inside surface of the inlet opening as well as the slit between the collar and the inside surface of the inlet opening. The diameter of the inlet opening and the perimeter of the collar are dimensioned in such a way that the sealing length of at the upper part of the furnace and the throttling effect do not significantly change at this stage. Rotation of the preform is still possible.

At the end of the process, the collar seals against the inlet opening and the sealing opening is formed by the slit between the collar and the handler. Preferably, this slot is shaped in such a way that the throttling effect of the inlet opening remains constant during the various stages of the process. Rotation of the preform is still possible. If the collar and the inlet opening are not necessarily sealed against each other by using sealing materials, it is possible to leave a slit between them, which provides for a sealing flow. Then, the throttling effect of the upper sealing zone is defined by two parallel conductances, viz. the slits between the collar and the handler and between the collar and the inlet opening. In the case examined herein, the chimney effect is much stronger and, at the same time, due care has to be taken that the sealing flow providing a diffusion barrier is strong enough at both ends of the furnace.

When we examine the drawing according to FIG. 14, we note that the furnace can be considered to be formed by 5 successive conductances (c1, c2, c3, c4 and c5), the total effect of which will throttle the chimney flow (for calculating the total effect, formula 5 can be used). Thus, for example in cases in which the slit between the furnace tube and the preform is very narrow, the dominating conductance of the system is formed at this place (the other conductances are smaller, even when taken together, than this conductance), which is the most dominating conductance of the whole arrangement. When this is the case, any variations of the slit of the inlet opening will not influence the magnitude of the furnace flow as dramatically as could be expected by only examining the conductance of the inlet opening. Preferably, the inner diameter of the inlet opening/tube and the inner diameter of the furnace tube should be essentially the same, which allows for minimization of the furnace effect of each inlet opening. In practice, when there is a variation of the sizes of the preforms, this is not always attainable outside standard production.

Based on the above, it is easy to understand that by selecting the inlet/feed point of the gas it is possible to influence the amount of gas needed. According to FIG. 7, the gas is divided into an upward-directed flow and a downward-directed flow, the respective amounts of which are determined by the ratio between the total conductances of the routes.

The upward-directed flow is restricted by the accumulated conductance of the conductances above the feeding point and the downward-directed flow is restricted by the accumulating conductance of the conductances below the feeding point, respectively. The total conductances can be calculated from formula 5. With these total conductances, it is possible to replace the conductances denoted “c1” and “c2” in equation 2 (in the case of two outlet, c3 can be omitted), whereby the flows directed upwards and downwards, respectively, can be calculated. When the position of the feed point is changed from above the dominating restriction to below it, c1 is reduced and c2 is increased. In other words, the part of the flow directed downwards is increased and the amount going upwards is reduced. Thus, by using a smaller flow rate is it possible to obtain a downward-directed flow, which will counteract the downward-directed flow. This feature becomes particularly important when the process is implemented in such a way that the preform is fed from below the furnace and the processed product is withdrawn from the furnace through the upper opening.

In the solution according to the invention, a loose lower opening was employed.

### EXAMPLE

In the example, the flow has calculated having the following dimensions:

| Preform diameter | 80 | mm |
|---|---|---|
| Preform length | 1000 | mm |
| Stretched preform diameter | 42.5 | mm |
| Handler diameter | 45 | mm |
| Diameter of upper opening | 83 | mm |
| Length of upper opening | 100 | mm |
| Diameter of lower opening | 83 | mm |
| Length of lower opening | 150 | mm |
| Collar inside diameter | 53 | mm |
| Collar inside length | 80 | mm |
| Collar outside diameter | 80 | mm |
| Collar outside length | 50 | mm |
| Furnace tube inside diameter | 93 | mm |
| Furnace tube length | 400 | mm |
| Used run parameters: | | |
| Inert gas | argon (Ar) | |
| Temperature | 1950° | C. |

The flow values were calculated at safe size by using formulas 1-6

The easiest way is to calculate the chimney effect through the furnace first and then calculate the gas distribution for the used feeding points. The needed diffusion barrier flow for lower iris flow was added to that flow. The sum flow was then used as inert gas flow value.

By using calculated values:

| | |
|---|---|
| Gas feed under upper opening | 30 SLM |
| Gas feed 150 mm under centerline | 15 SLM |

Generally, feeding a significant part, e.g. about 5-100%, in particular 50-100% (calculated from the fed mass flow), of the gas at or below the centerline of the furnace tube (the point where the temperature is highest in the furnace) has been advantageous in the method and the apparatus according to the invention.

The construction worked well and no oxygen damages were noticed.

When the conductances are calculated, it is important to consider what kind of gas actually is employed (e.g. its density) and to apply coefficients for correcting the temperature effects in the equations mentioned above.

Within the scope of the present invention, alternative embodiments are also possible. Thus, as shown in FIG. 8, it is possible to fit the barrier tube up or inside the furnace or the furnace tube can work as a barrier tube. A combination of these alternatives is also possible. It is further possible to adapt the apparatus to thickness variations by using a plurality of barrier tubes, which are fitted inside each other. The gas feed can take place from an upper inlet, a lower inlet or through a nozzle in the middle of the furnace, or as a combined feed into two or three of these feed points. As discussed above, it is possible to arrange a barrier space inside the furnace to allow for regulation of the flow rates and volumes as a function of the thickness of the preform and the thickness variations thereof.

Although the above description describes tensional processing, the same principles can be applied to compression processing of glass preforms. Also processing in which no tension is used, are covered by the present invention.

The protective flows can be achieved by feeding the gas or by using suction and these flows can be arranged to be opposite to separate two volumes from each other. There can be several barrier flows at the flow system. The method is applicable to processing of tubes, rods and empty tubes.

A particularly interesting embodiment comprises the use of a rotary joint accomplished by the present diffusion barrier principle in MCVD lathes. By this sealing method, many of the problems related to leaks and wear of present-day rotary joints can be mitigated or even eliminated. In particular, the present invention provides a technical advantageous solution for non-contact sealing when hot and/or aggressive gases are fed into the lathe during the deposition/growth stage of the process.

1. A method of subjecting a glass preform to processing by tensile forces in a furnace to produce a glass product of predetermined shape, according to which method
at least a part of the glass preform is introduced into the furnace through an inlet opening,
a portion of the glass preform introduced into the furnace is heated to a temperature above the softening point of the glass,
the heated portion of the glass preform is subjected to tensile forces in a drawing direction to process the preform into the predetermined shape,
the portion of the preform which has been processed into the predetermined shape is drawn from the furnace through an outlet opening, and
the heated portion of the preform and at least a part of the processed portion of the preform are flushed in the furnace with inert gas which is being fed into the furnace,
characterized by
maintaining the concentration of gaseous impurities in the furnace essentially on the same level as the concentration of the same impurities in the inert gas fed into the furnace,
establishing a diffusion barrier against the inflow of undesired gaseous components from the ambient air, driven by the forces of diffusion, by generating a barrier flow of inert gas in at least one opening selected from said inlet opening and said outlet opening of the furnace, said barrier flow having a direction of flow, which is generally opposite to the direction of the diffusion.

2. The method according to claim 1, wherein the furnace comprises an elongated furnace chamber having a vertical central axis, said diffusion barrier being established in the inlet opening, which is located in the upper end of the elongated furnace chamber.

3. The method according to claim 1, wherein a diffusion barrier is established in the inlet opening of the glass preform, in the inlet opening of the inert gas feed and in the outlet opening of the processed preform.

4. The method according to claim 2, wherein there is gas flow through the inlet opening of the glass preform, which flow corresponds to the equation (2)
F1=F*C1/(C1+C2). (2)
wherein
F1 stands for the gas flow through the inlet opening,
F stands for the total gas flow,
C1 stands for the conductance of the inlet opening and
C2 stands for the conductance of the outlet opening.

5. The method according to claim 4, wherein the each of the conductances C1 and C2 are calculated from the equation (3)
C=K W*H³/L, (3)
wherein
C stands for conductance,
K is a constant at low pressure differences,
W is the width of the opening,
H is the height of the opening, and
L is the length of the opening.

6. The method according to claim 1, wherein there is a flow of inert gas through the outlet opening, which flow is at least equal to the flow of gas caused by the chimney effect through the inlet opening.

7. The method according to claim 6, wherein the flow of inert gas into the furnace is sufficient still to form, based on the gas distribution according to equation (2), a diffusion barrier at the outlet opening of the processed preform.

8. The method according to claim 7, wherein the outlet opening will allow for more free flow of gas than the inlet opening to direct most of the inert gas flow fed into the furnace through the outlet opening.

9. The method according to claim 3, wherein the conductance of the outlet opening is greater than the conductance of the inlet opening.

10. The method according to claim 1, wherein the inert gas fed into the furnace is equal to or greater than the flow of gas caused by the chimney effect+1 SLM, in particular chimney effect+5 SLM.

11. The method according to claim 1, wherein the glass preform is subjected to tensile drawing in order to stretch the preform into a shape suitable for post-processing like drawing of optical fibres.

12. The method according to claim 1, wherein the glass preform is subjected to drawing of optical fibre.

13. The method according to claim 12, wherein the clearance between the exterior diameter of the glass preform and the inlet opening diameter is 0.1-10 mm for an 80 mm preform.

14. The method according to claim 12, wherein there is a barrier flow along a barrier distance of 0.5 to 100 mm.

15. The method according to claim 1, wherein the furnace comprises a graphite induction furnace.

16. The method according to claim 1, comprising rotating the glass preform about its central axis during heat-processing in the furnace.

17. An apparatus for heating of glass performs which are processed by tensile forces into a glass product of predetermined shape, comprising
a furnace body having a jacket defining an elongated furnace chamber with an at least essentially circular cross-section perpendicular to the central axis of the chamber,
a first opening at one end of the chamber for receiving one end of a glass preform, which is to be processed,
a second opening at an opposite end of the chamber for withdrawal of the processed glass product,
graphite heating resistances mounted to the furnace chamber to provide for induction heating of the glass preform in the furnace, and
feed nozzles connected to at least the first opening of the chamber for introducing protective gas into the furnace chamber,
characterized by
a first diffusion barrier zone at the first opening for preventing inflow of undesired gaseous components from the ambient air, driven by the forces of diffusion, into the furnace chamber during heating of the glass preform.

18. The apparatus according to claim 17, wherein there is a second diffusion barrier zone at the second opening of the furnace chamber.

19. The apparatus according to claim 17, wherein a nozzle for feed of protective gas is connected to both the first and the second openings and, optionally, also to an opening formed in the jacket of the furnace chamber at a point between the first and the second openings.

20. The apparatus according to claim 17, wherein the apparatus is adapted for heating of a glass preform subjected to drawing of optical fibre.

21. The apparatus according to claim 20, wherein the clearing between the exterior diameter of the glass preform and the first opening diameter is 0.1-10 mm for an 80 mm preform.

22. The apparatus according to claim 21, wherein the each barrier zone comprises a length of the furnace chamber amounting to 0.5 to 100 mm, along which a barrier flow of protective gas can be arranged.

23. The apparatus according to claim 17, wherein the barrier zone comprises a zone of essentially laminar gas flow.

24. The apparatus according to claim 23, wherein the barrier zone is formed above the feed nozzles of the protective gas.

25. The apparatus according to claim 17, wherein the barrier zone is defined by the clearance between a glass preform and the opening of the furnace.

26. The apparatus according to claim 25, wherein the difference between the external diameter of the glass preform and inner diameter of the opening is in the range of 0.5 to 15 mm.

27. The apparatus according to claim 23, wherein the barrier zone has a length parallel to the central axis of the furnace tube amounting to about 10 to 1000 mm, preferably about 15 to 150 mm.

28. A process for heat-treatment of glass substrates, in which method the glass substrate is placed in a first gas space of a heat treatment zone, surrounded by a second, ambient gas space, said heat treatment zone being provided with at least one gas conduit interconnecting the first and the second gas spaces, characterized by forming a diffusion barrier in the at least one gas conduit interconnecting the gas space inside the heat treatment device with the ambient atmosphere to seal off the conduit against flow of gas in at least one direction through the conduit.

29. The process according to claim 28, comprising establishing a diffusion barrier against the inflow or outflow of undesired gaseous components from or to the ambient air, driven by the forces of diffusion, by generating a barrier flow of inert gas in at least one said gas conduit, said barrier flow having a direction of flow, which is generally opposite to the direction of the diffusion.

30. The process according to claim 28, comprising establishing a diffusion barrier in each of the gas conduits interconnecting the first and the second gas spaces.

31. The process according to claim 28, wherein the heat treatment comprises preform processing by Modified Chemical Vapour Deposition in an MCVD lathe.

32. The process according to claim 28, wherein the heat treatment comprises preform processing in a sintering furnace.

33. The process according to claim 28, wherein the diffusion barrier is established at a gas conduit comprising a rotary joint.

34. The process according to claim 33, wherein the rotary joint is a non-contacting joint.
